(19) United States
(12) Patent Application Publication
(10) Pub. No.: US 2025/0231015 A1
(43) Pub. Date: Jul. 17, 2025

(54) Wheeled Distance Measuring Device

(71) Applicant: Shenzhen YiyouJiapin Network Technology Co., Ltd, Shenzhen (CN)

(72) Inventor: LiFen Zhang, Ganzhou (CN)

(21) Appl. No.: 18/594,612

(22) Filed: Mar. 4, 2024

(30) Foreign Application Priority Data
Jan. 16, 2024 (CN) 202420108077.X

(51) Int. Cl. G01B 3/12

(52) U.S. Cl. CPC G01B 3/12

(57) ABSTRACT

A wheeled distance measuring device includes: a first clamping base, a second clamping base and a roller shaped measuring body; the first clamping base is provided with a mounting axis, used to fixedly connected to the second clamping base; the surrounding of the measuring body is provided with a measuring surface abutted with the surface of the measured object; a scale is arranged along the surrounding of the measuring body. This wheeled distance measuring device has a simple structure, is easy to assemble and convenient to operate, and reduces the cost of production efficiently.

### FIELD OF THE INVENTION

The present utility patent relates to the measuring instruments technology, and more particularly, to a wheeled distance measuring device.

### BACKGROUND OF THE INVENTION

In real life, people often use measuring tools (such as rulers and tape measures) to measure map scales, object outlines, furniture dimensions and room sizes; however, for measurement objects with uneven and complex outlines, such as sofa cushions or seats backrests, etc. Due to their limited curvature, traditional rulers and tape measures cannot fully fit the surface of the object for accurate measurement, resulting in large measurement deviations.

An electronic roller scale is provided in the prior art. For example, Chinese utility model CN208520349U discloses an electronic roller scale. The electronic roller scale comprises a fixed base, a roller and a display screen. The fixed base is a disc-shaped structure with an inner cavity; the roller can be rotated and is arranged on the outer surrounding surface of the fixed base, and is connected with the electronic detection component through the transmission component, wherein the electronic detection component is arranged in the inner cavity and is used for recording the rotation angle of the roller. The display screen is arranged on the end surface of the fixed base for displaying the electronic detection information. When this electronic roller measures small sizes, users can clamp the fixed base with their hands, and the roller rolls around the fixed base on the surface of the measured object to measure the measured size. However, this electronic roller scale requires a transmission part between the roller and the electronic detection piece, resulting in a complex internal structure and high assembly cost, and the accuracy of the transmission part will affect the measurement accuracy.

### SUMMARY OF THE INVENTION

The purpose of this present utility patent is to provide a wheeled distance measuring device to solve the problem in the prior art that the internal structure of the electronic roller scale is complex, the assembly cost is high, and the accuracy of the transmission parts will affect the measurement accuracy of the electronic roller scale.

In order to serve the above purposes, the technical scheme adopted by the present utility patent is: a wheeled distance measuring device, which comprises a first clamping base, a second clamping base and a roller shaped measuring body arranged between the first clamping base and the second clamping base; the first clamping base is provided with a mounting axis, which is used to fixedly connected with the second clamping base; a penetration hole is penetrated arranged in the measuring body, used for the mounting axis penetrating; the surrounding of the measuring body is provided with the measuring surface abutted with the surface of the measured object; the measuring body is provided with a first surface towards the first clamping base and a second surface towards the second clamping base; a scale is arranged along the surrounding of the measuring body on the second surface.

In a embodiment, the wheeled distance measuring device also comprises a rolling bearing arranged on the mounting axis; the rolling bearing is arranged between the mounting axis and the measuring body.

In a embodiment, the measuring surface of the measuring body is provided with an anti-slip piece.

In a embodiment, the wheeled distance measuring also comprises moveable components, used to prompt the number of the rotation of the measuring body; the first surface of the measuring body concaves inward to constitute a mounting slot, used for mounting the moveable components; the position of the mounting slot corresponds to the position of the “0” tick mark of the scale; the surface of the first clamping base concaves inward to constitute an abdication slot, used for the moveable components to be placed in.

In a embodiment, the moveable components comprise a moveable block arranged in the mounting slot and an elastic piece used to drive the moveable block to move relative to the measuring body; the moveable block is capable of placing in the abdication slot and abutting with the bottom of the abdication slot.

In a embodiment, a protective cover is arranged on the second clamping base, used to cover the second surface of the measuring body; the covering position of the protective cover corresponds to the position of the scale; the observation port is penetrated arranged in the protective cover, used for users to read the number of the scale.

In a embodiment, a symbol piece is arranged on the surrounding side wall of the observation port of the protective cover.

After adopting the above technical scheme, the beneficial effect of the present utility patent is: compared to existing technology, this wheeled distance measuring device comprises a first clamping base, a second clamping base and a roller shaped measuring body arranged between the first clamping base and the second clamping base; the first clamping base is provided with a mounting axis, which is used to fixedly connected with the second clamping base; a penetration hole is penetrated arranged in the measuring body, used for the mounting axis penetrating; the mounting axis of the first clamping base penetrates through the penetration hole of the measuring body and connected with the second clamping base, which realizes the goal of clamping and fixing the measuring body by the first clamping base and the second clamping base; the surrounding of the measuring body is provided with a measuring surface abutted with the surface of the measured object; the measuring body is provided with a first surface towards the first clamping base and a second surface towards the second clamping base; a scale is arranged along the surrounding of the measuring body. As the outer perimeter of the roller shaped measuring body is a fixed value, the surface profile of the measured object could be measured by making the measuring surface of the measuring body abutted with the surface of the measured object and driving the measuring body to take the installation axis as the center of rotation to rotate relative to the first clamping base to move the wheeled distance measuring device along the surface of the measured object. Users could clamp the wheeled distance measuring device on opposite sides surface by thumb and index finger, which realizes the goal of driving the wheeled distance measuring device to move relative to the measured object by using two fingers clamping to operate measuring. This present utility patent is provided with a measuring body whose measuring surface is abutted with the surface of the measured object; the wheeled distance measuring device moves along the surface of the measured object and obtains measuring data by the scale of the measuring body intuitively, which could measure the surface profile of the measured object and ensure the measuring accuracy. The wheeled distance measuring device has a simple structure, is easy to assemble and convenient to operate, and reduces the cost of production efficiently.

### DESCRIPTION OF THE DRAWINGS

In order to provide a clearer description of the embodiment regarding the present utility patent or the technical scheme in the prior art, below is a brief introduction to the drawings required in the embodiment or prior art description. Obviously, the drawings in the following description only relate to some embodiments of the present utility patent. For ordinary technicians in this art, other drawings can be obtained based on these ones without providing any creative labor.

FIG. 1 is a schematic diagram of three-dimensional structure of the wheeled distance measuring device;

FIG. 2 is an explosion diagram of the wheeled distance measuring device;

FIG. 3 is a schematic diagram of three-dimensional structure of the first clamping piece in the wheeled distance measuring device;

FIG. 4 is a schematic diagram one of three-dimensional structure of the second clamping piece in the wheeled distance measuring device;

FIG. 5 is a schematic diagram two of three-dimensional structure of the first clamping piece in the wheeled distance measuring device;

FIG. 6 is a schematic diagram one of three-dimensional structure of the measuring body in the wheeled distance measuring device;

FIG. 7 is a schematic diagram two of three-dimensional structure of the measuring body in the wheeled distance measuring device;

Explanation of reference symbols: 1. wheeled distance measuring device; 2. first clamping base; 21. mounting axis; 22. abdication slot; 3. second clamping base; 31. protective cover; 311. observation port; 312. symbol piece; 4. measuring body; 41. penetration hole; 43. measuring surface; 43. first surface; 44. second surface; 45. anti-slip piece; 46. mounting slot; 5. scale; 6. rolling bearing; 7. moveable block.

### DETAILED DESCRIPTION OF THE PREFERRED EMBODIMENT

In order to make the technical problems, technical solutions and beneficial effects to be solved by this application more clear, this application will be further described in detail below in conjunction with the accompanying drawings and embodiments. It should be understood that the specific embodiments described here are only used to explain the present application and are not used to limit the present application.

It should be noted that when an element is referred to as “being fixed” or “arranged” on another element, it can be directly or indirectly on the another element. When an element is referred to as “being connected” to another element, it can be directly or indirectly connected to the another element.

It should be understood that the terms “length” “width” “upper” “lower” “front” “back” “left” “right” vertical” “horizontal” “top” “bottom” “inner” “outer”, etc., are based on the orientations or positional relationships shown in the drawings. They are only for the convenience of describing the present utility patent and simplifying the description, rather than indicating or implying the device referred to or element must have a specific orientation and orientation to be constructed and operated. Therefore, they are not to be considered to be limitations on the patent.

Moreover, the terms “first” “second” are only for describing aims, rather than indicating or implying relative importance or implicitly specify the number of indicated technical characteristics. Therefore, features defined as “first” and “second” explicitly or implicitly include one or more of these features. In the description of some patents, “several” means two or more, unless otherwise specific limitations.

Please see FIGS. from 1 to 8, this present utility patent provides a wheeled distance measuring device 1, which comprises a first clamping base 2, a second clamping base 3 and a measuring body 4 arranged between the first clamping base 2 and the second clamping base 3; the first clamping base 2 is provided with a mounting axis 21, which is used to fixedly connected with the second clamping base 3; a penetration hole 41 is penetrated arranged in the measuring body 4, used for the mounting axis 21 penetrating; the mounting axis 21 of the first clamping base 2 penetrates through the penetration hole 41 of the measuring body 4 and fixedly connected with the second clamping base 3 to realize the goal of clamping and fixing the measuring body 4 by the first clamping base 2 and the second clamping base 3; the surrounding of the measuring body 4 is provided with a measuring surface 42 abutted with the surface of the measured object; the measuring body 4 is provided with a first surface 43 towards the first clamping base 2 and a second surface 44 towards the second clamping base 3; a scale 5 is arranged along the surrounding of the measuring body 4. As the outer perimeter of the measuring body 4 is a fixed value, the surface profile of the measured object could be measured by making the measuring surface 42 of the measuring body 4 abutted with the surface of the measured object and driving the measuring body 4 to take the mounting axis 21 as the center of rotation to rotate relative to the first clamping base 2 to move the wheeled distance measuring device 1 along the surface of the measured object. Users could clamp the wheeled distance measuring device 1 on opposite sides surface by thumb and index finger, which realizes the goal of driving the wheeled distance measuring device 1 to move relative to the measured object by using two fingers clamping to operate measuring. This wheeled distance measuring device 1 is provided with a measuring body 4, whose measuring surface 42 is abutted with the surface of the measured object; the wheeled distance measuring device 1 moves along the surface of the measured object and obtains measuring data by the scale 5 of the measuring body 4 intuitively, which could measure the surface profile of the measured object and ensure the measuring accuracy. The wheeled distance measuring device 1 has a simple structure, is easy to assemble and convenient to operate, and reduces the cost of production efficiently.

Please see FIGS. from 1 to 5, as one embodiment of the wheeled distance measuring device 1, there is no limitation of the connecting ways between the first clamping base 2 and the second clamping base 3 of the wheeled distance measuring device 1, which cloud be detachably connected or undetachably connected. Optionally, the first clamping base 2 detachably connected with the second clamping base 3 of the wheeled distance measuring device 1, the mounting axis 21 detachably connected with the second clamping base 3, which realizes the goal of clamping and fixing the measuring body 4 by the first clamping base 2 and the second clamping base 3, which has a simple structure, is easy to assemble and disassemble. Optionally, the first clamping base 2 threaded connected with the second clamping base 3, the second clamping base 3 is provided with a fixed slot used for setting the mounting axis 21; the side wall of the fixed slot is provided with a internal thread; the outside wall of the mounting axis 21 is provided with an outer thread suited to the internal thread. The first clamping base 2 undetachably connected with the second clamping base 3 by the threaded connection, which realizes the goal of clamping and fixing the measuring body 4 by the first clamping base 2 and the second clamping base 3 to make the measuring body 4 rotate between the first clamping base 2 and the second clamping base 3, which has a simple structure and is convenient to produce, and convenient for users to assemble and disassemble. Optionally, the first clamping base 2 undetachably connected with the second clamping base 3 of the wheeled distance measuring device 1; making the second clamping base 3 adhesive connected with the end surface of the mounting axis 21, which realizes the goal of clamping and fixing the measuring body 4 by the first clamping base 2 and the second clamping base 3, which has a simple structure, is easy to assemble.

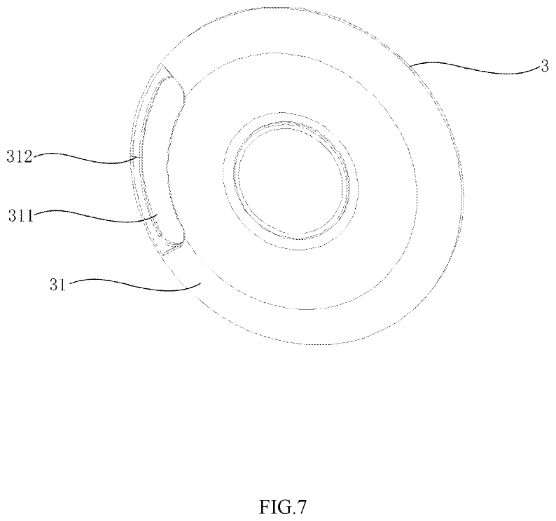

Please see FIGS. 2, 7 and 8, in this embodiment, the wheeled distance measuring device 1 also comprises a rolling bearing 6 arranged on the mounting axis 21, the rolling bearing 6 is arranged between the mounting axis 21 and the measuring body 4, which reduces the friction between the mounting axis 21 and the measuring body 4 effectively, helping users saving efforts and improving users experience.

Optionally, the measuring surface 42 of the measuring body 4 is provided with an anti-slip piece 45, which could increase the friction between the surface of the measured object and the measuring surface 42 of the measuring body 4. On one hand, it could save efforts for users when operating, on the other hand, it could prevent the measuring body 4 from idling when rolling on the surface of the measured object, which is beneficial to ensure the measurement accuracy of the wheeled distance measuring device 1. Optionally, the anti-slip piece 45 is an anti-slip protrusion or anti-slip groove arranged on the measuring surface 42 of the measuring body 4.

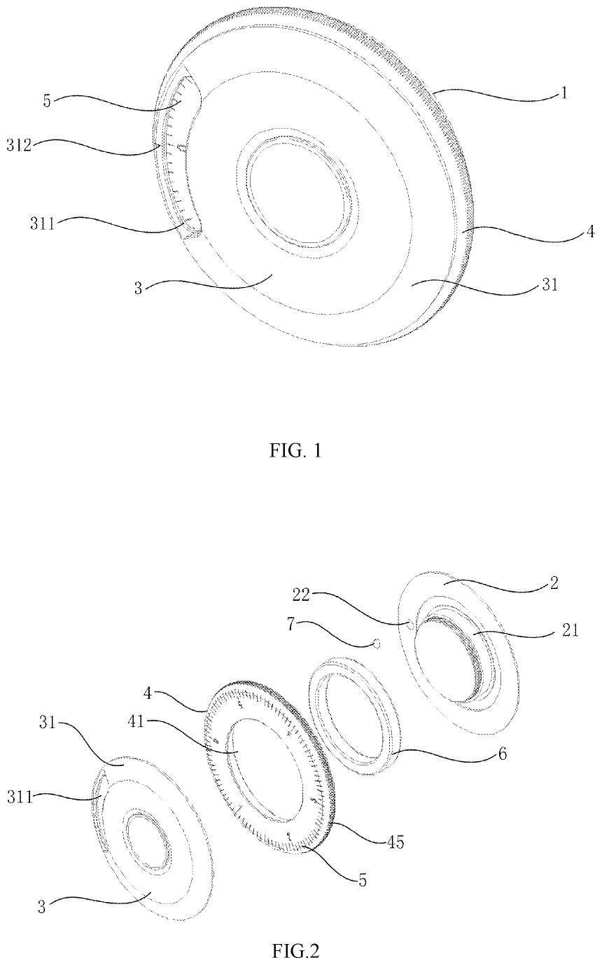

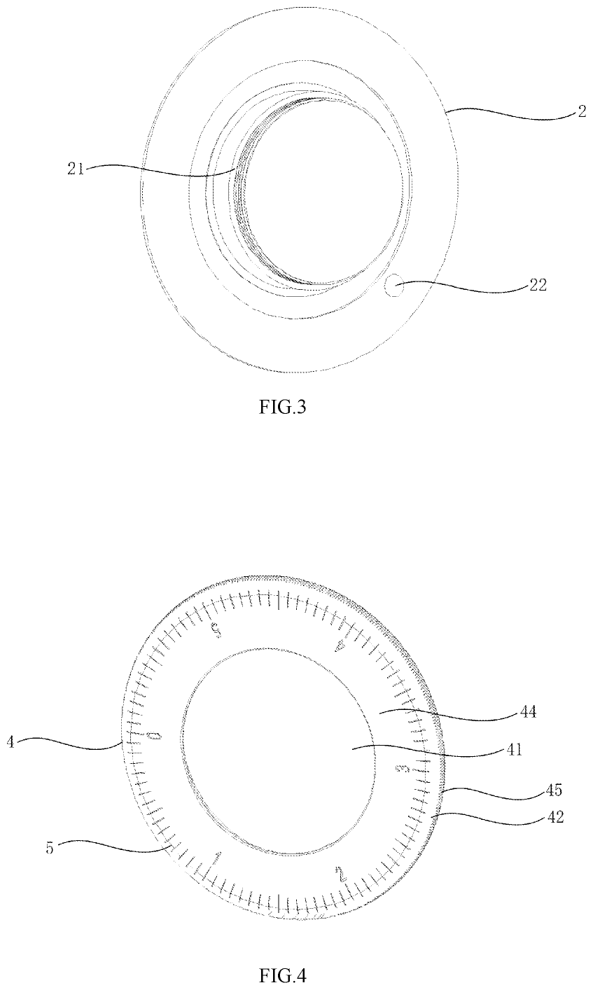

Please see FIGS. 1, 2, 4 and 8, in this embodiment, the wheeled distance measuring device 1 also comprises moveable components, used to prompt the number of the rotation of the measuring body 4; the first surface 43 of the measuring body 4 concaves inward to constitute a mounting slot 46, used for mounting the moveable components; the position of the mounting slot 46 corresponds to the the position of the “0” tick mark of the scale 5; the surface of the first clamping base 2 concaves inward to constitute an abdication slot 22, used for the moveable components to be placed in. When the measuring body 4 takes the installation axis 21 as the center of rotation to rotate relative to the first clamping base 2, the moveable components arranged in the mounting slot 46 of the measuring body 4 rotates relative to the first clamping base 2 with the measuring body rotating. Therefore, as the measuring body 4 rolls a circle in the surface hub of the measured object, the moveable takes the installation axis 21 as the center of rotation to rotate. As the position of the mounting slot 46 corresponds to the position of the “0” tick mark of the scale 5, which means the installation position of the moveable components corresponds to the position of the “0” tick mark of the scale. When using the wheeled distance measuring device 1, users could rotate the measuring body 4 first to make the position of the abdication slot 22 of the first clamping base 2 corresponds to the position of the “0” tick mark of the scale 5, and then make the measuring surface 42 of the measuring body 4 abutted with the surface of the measured object, driving the measuring body 4 to take the installation axis 21 as the center of rotation to rotate, and when the moveable components rotate to the position of the abdication slot 22 of the first clamping base 2, it is arranged in the abdication slot 22 and collided with the surface of the first clamping base 2, making a bleep to prompt the rotation numbers of the measuring body 4. As the outer perimeter of the roller shaped measuring body 4 is a fixed value, users could obtain the rotation numbers of the measuring body 4 according to the collision numbers between the moveable components and the first clamping base 2, meantime reading the number of the scale 5 of the measuring body 4, thus inferring the moving distance of the wheeled distance measuring device 1 in the measured object surface and then inferring the measuring data of the surface profile of the measured object, which has a simple structure and is convenient to operate.

Optionally, the moveable components comprise a moveable block 7 arranged in the mounting slot 46 and an elastic piece used to drive the moveable block 7 to move relative to the measuring body 4; the moveable block 7 is capable of being placed in the abdication slot 22 and abutted with the bottom of the abdication slot 22. When users use the wheeled distance measuring device 1, turning the measuring body 4 firstly to make the position of the abdication slot 22 of the first clamping base 2 corresponds to the position of the “0” tick mark of the scale 5, and then making the measuring surface 42 of the measuring body 4 abutted with the surface of the measured object, at this time, the moveable block 7 is arranged in the abdication slot 22 under the action of elastic force of elastic piece and abutted with the bottom of the abdication slot 22. When the measuring body 4 is driven to take the mounting axis 21 as the center of rotation and relative to the first clamping base 2 to rotate, the moveable components are driven to take the mounting axis 21 as the center of rotation to rotate followed by, at this time, the moveable block 7 is placed outside of the abdication slot 22 and arranged in the mounting slot 46 under the extrusion function of the first clamping base 2; the elastic piece is compressed under the extrusion function of the moveable block 7. As the measuring body 4 rolls a circle in the surface hub of the measured object, the moveable components takes the installation axis 21 as the center of rotation to rotate a circle followed by; at this time, the position of the abdication slot 22 corresponds to the position of the “0” tick mark of the scale 5. The moveable block is rejected from the mounting slot 46 of the measuring body 4 under the elasticity function of the elastic piece and arranged in the abdication slot 22 and collided with the bottom of the the abdication slot 22, making a bleep to prompt the rotation numbers of the measuring body 4. As the outer perimeter of the roller shaped measuring body 4 is a fixed value, users could obtain the rotation numbers of the measuring body 4 according to the collision numbers between the moveable block 7 and the abdication slot 22, meantime reading the number of the scale 5 of the measuring body 4, thus inferring the moving distance of the wheeled distance measuring device 1 in the measured object surface and then inferring the measuring data of the surface profile of the measured object. Optionally, the elastic piece is a spring or shrapnel, which has a simple structure, is easy to assemble and product.

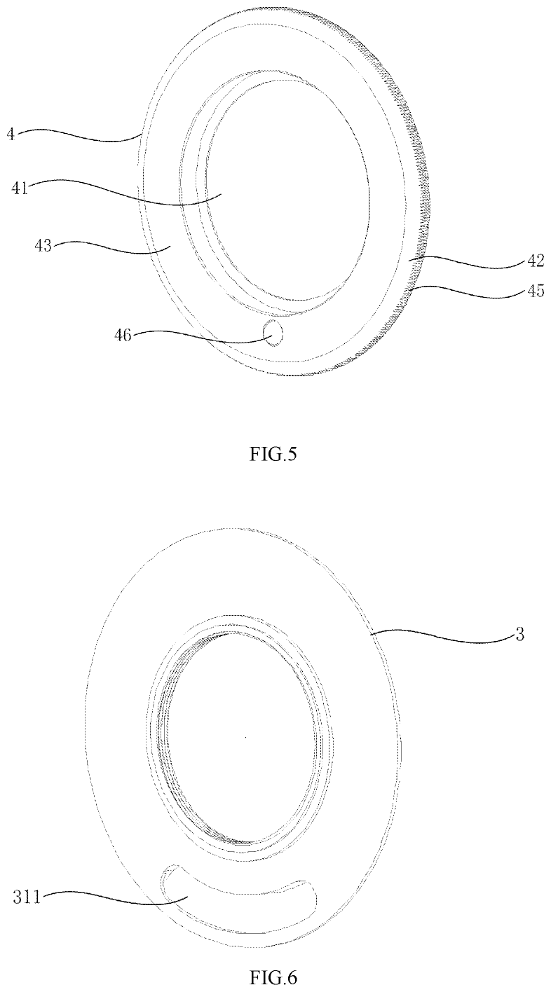

Please see FIGS. 1, 2, 5 and 6, in this embodiment, the second clamping base 3 is provided with a protective cover 31, used for covering the second surface 44 of the measuring body 4; the covering position of the protective cover 31 corresponds to the position of the scale 5, which prevents the scale 5 of the measuring body 4 from being worn during use and is beneficial for extending service life of the wheeled distance measuring device 1. Optionally, the observation port 311 is penetrated arranged in the protective cover 31, used for users to read the number of the scale 5 of the measuring body 4.

Optionally, a symbol piece 312 is arranged on the surrounding side wall of the observation port 311 of the protective cover 31, which is beneficial for users to calibrate the scale 5 and meantime reading the number of the scale 5 fast and accurately. When users use the wheeled distance measuring device, they should adjust the position of the symbol piece 312 of the protective 31 to correspond to the position of the “0” tick mark of the scale 5; and adjust the position of the abdication slot 22 of the first clamping base 2 correspond to the position of the symbol piece 312, which helps users to scroll the “0” tick mark of the scale 5 of the measuring body 4 correspond to the position of the symbol piece 312, making the device become more convenient and improving the users experience.

All above is only a better embodiment of the present utility patent, instead of a limitation. Those technicians in the art make other modifications or equivalent replacement to this embodiment, as long as they do not deviate from the spirit and scope of the technical solutions of the present utility patent, all should be covered by the claims of the present utility patent.

What is claimed is:

1. A wheeled distance measuring device, comprising: a first clamping base, a second clamping base, and a roller shaped measuring body arranged between the first clamping base and the second clamping base; the first clamping base is provided with a mounting axis, which is used to fixedly connected with the second clamping;
a penetration hole is penetrated arranged in the roller shaped measuring body, used for the mounting axis penetrating; wherein the surrounding of the roller shaped measuring body is provided with a measuring surface abutted with the surface of the measured object; the roller shaped measuring body is provided with a first surface towards the first clamping base and a second surface towards the second clamping base;
a scale is arranged along the surrounding of the roller shaped measuring body.

2. The wheeled distance measuring device according to claim 1, further comprising a rolling bearing arranged on the mounting axis, wherein the rolling bearing is arranged between the mounting axis and the roller shaped measuring body.

3. The wheeled distance measuring device according to claim 1, wherein the measuring surface of the roller shaped measuring body is provided with an anti-slip piece.

4. The wheeled distance measuring device according to claim 1, further comprising moveable components used to prompt number of the rotation of the roller shaped measuring body, wherein the first surface of the roller shaped measuring body concaves inward to constitute a mounting slot, used for mounting the moveable components; the position of the mounting slot corresponds to the position of the “0” tick mark of the scale; surface of the first clamping base concaves inward to constitute an abdication slot, used for the moveable components to be placed in.

5. The wheeled distance measuring device according to claim 4, wherein the moveable components comprise a moveable block arranged in the mounting slot and an elastic piece used to drive the moveable block to move relative to the roller shaped measuring body; the moveable block is capable of placing in the abdication slot and abutting with the bottom of the abdication slot.

6. The wheeled distance measuring device according to claim 1, wherein a protective cover is arranged on the second clamping base, used to cover the second surface of the roller shaped measuring body; the covering position of the protective cover corresponds to the position of the scale; an observation port is penetrated arranged in the protective cover, used for users to read the number of the scale.

7. The wheeled distance measuring device according to claim 6, wherein a symbol piece is arranged on one surrounding side wall of the observation port of the protective cover.
